(19) United States
(12) Patent Application Publication
(10) Pub. No.: US 2014/0168153 A1
(43) Pub. Date: Jun. 19, 2014

(54) TOUCH SCREEN SYSTEMS AND METHODS BASED ON TOUCH LOCATION AND TOUCH FORCE

(71) Applicant: CORNING INCORPORATED, CORNING, NY (US)

(72) Inventors: Oberon Denaci Deichmann, Corning, NY (US); William James Miller, Horseheads, NY (US); Lucas Wayne Yeary, Corning, NY (US)

(73) Assignee: CORNING INCORPORATED, CORNING, NY (US)

(21) Appl. No.: 14/102,936

(22) Filed: Dec. 11, 2013

Related U.S. Application Data
(60) Provisional application No. 61/738,047, filed on Dec. 17, 2012.

(51) Int. Cl. G06F 3/044

(52) U.S. Cl. CPC G06F 3/044
USPC 345/174

(57) ABSTRACT

Touch screen systems and methods based on touch location and touching force are disclosed. The touch screen system includes an optical force-sensing system interfaced with a capacitive touch sensing system so that both touch location and touch force information can be obtained. A display that utilizes the touch screen system is also disclosed.

### CROSS REFERENCE TO RELATED APPLICATIONS

This application claims the benefit of priority under 35 U.S.C. §119 of U.S. Provisional Application Ser. No. 61/738,047, filed on Dec. 17, 2012, the content of which is relied upon and incorporated herein by reference in its entirety.

### FIELD

The present disclosure relates to touch screens, and in particular to touch screen systems and methods that are based on touch location and touch force. All publications, articles, patents, published patent applications and the like cited herein are incorporated by reference herein in their entirety, including U.S. Provisional Patent Applications No. 61/564,003 and 61/564,024.

### BACKGROUND ART

The market for displays and other devices (e.g., keyboards) having non-mechanical touch functionality is rapidly growing. As a result, touch-sensing techniques have been developed to enable displays and other devices to have touch functionality. Touch-sensing functionality is gaining wider use in mobile device applications, such as smart phones, e-book readers, laptop computers and tablet computers.

Touch-sensitive surfaces have become the preferred method where users interact with a portable electronic device. To this end, touch systems in the form of touch screens have been developed that respond to a variety of types of touches, such as single touches, multiple touches, and swiping. Some of these systems rely on light-scattering and/or light attenuation based on making optical contact with the touch-screen surface, which remains fixed relative to its support frame. An example of such a touch-screen system is described in U.S. Patent Application Publication No. 2011/0122091.

Commercial touch-based devices such as smart phones currently detect an interaction from the user as the presence of an object (i.e. finger, stylus) on or near the display of the device. This is considered a user input and can be quantified by 1) determining if an interaction has occurred, 2) calculating the X-Y location of the interaction, and 3) determining the length of interaction.

Touch screen devices are limited in that they can only gather location and timing data during user input. There is a need for additional intuitive inputs that allow for efficient operation and are not cumbersome for the user. By using touch events and input gestures, the user is not required to sort through tedious menus which save both time and battery-life. Application programming interfaces (API) have been developed that characterize user inputs in the form of touches, swipes, and flicks as gestures that are then used to create an event object in software. However, the more user inputs that can be included in the API, the more robust the performance of the touch screen device.

### SUMMARY

The present disclosure is directed to a touch screen device that employs both location and force inputs from a user during a touch event. The force measurement is quantified by deflection of a cover glass during the user interaction. The additional input parameter of force is thus available to the API to create an event object in software. An object of the disclosure is the utilization of force information from a touch even with projected capacitive touch (PCT) data for the same touch event to generate software based events in a human controlled interface.

Force touch sensing can be accomplished using an optical monitoring systems and method, such as the systems and methods described in the following U.S. Provision Patent Applications: 61/640,605; 61/651,136; and 61/744,831.

Many types of touch sensitive devices exist, such as analog resistive, projected capacitive, surface capacitive, surface acoustic wave (SAW), infrared, camera-based optical, and several others. The present disclosure is described in connection with a capacitive-based device such as a Projected Capacitive Touch (PCT) device, which has the advantage that it enables multiple touch detection and is very sensitive and durable. The combination of location sensing and force sensing in the touch screen system disclosed herein enables a user to supply unique force-related inputs (gestures). A gesture such as the pinch gesture can thus be replaced with pressing the touchscreen with different amounts of force.

There are numerous advantages to a touch screen device that utilizes a combination of force sensing and location sensing. The primary advantage of using force monitoring is the intuitive interaction it provides for the user experience. It allows the user to press on a single location and modulate an object property (e.g., change a graphical image, change volume on audio output, etc.). Previous attempts at one-finger events employ long-press gestures, such as swiping or prolonged contact with the touch screen. Using force data allows for faster response times that obviate-press gestures. While a long-press gesture can operate using a predetermined equation for the response speed (i.e. a long-press gesture can a page to scroll at a set speed or at a rapidly increasing speed), force-based sensing allows the user to actively change the response time in a real-time interaction. The user can thus vary the scroll for instance simply by varying the applied touching force. This provides a user experience that is more interactive and is operationally more efficient.

Moreover, the use of force sensing combined with location sensing enable a wide variety of new touch-screen functions (APIs) as described below.

Additional features and advantages of the disclosure are set forth in the detailed description that follows, and in part will be readily apparent to those skilled in the art from that description or recognized by practicing the disclosure as described herein, including the detailed description that follows, the claims, and the appended drawings.

The claims as well as the Abstract are incorporated into and constitute part of the Detailed Description set forth below.

### BRIEF DESCRIPTION OF THE DRAWINGS

FIG. 1A is a schematic diagram of an example touch screen system according to the disclosure that is capable of measuring touch location using a capacitive touch screen and also measuring the applied force at the touch location using an optical force-sensing system;

FIG. 1B is a schematic diagram of a display system that employs the touch screen system of FIG. 1A;

FIG. 2A is an exploded side view of an example display system that employs the touch screen system of FIG. 1A;

FIG. 2B is a side view of the assembled display system of FIG. 2A;

FIG. 2C is a top-down view of the example display system of FIG. 2B but without the transparent cover sheet;

FIG. 2D is a top-down view of the display system of FIG. 2B with the transparent cover sheet;

FIG. 3A is an elevated view of an example proximity sensor shown relative to an example light-deflecting element and electrically connected to the microcontroller;

FIGS. 3B and 3C are top-down views of the proximity sensor illustrating how the deflected light covers a different area of the photodetector when the light-deflecting element moves towards or away from the proximity sensor and/or rotates relative thereto;

FIGS. 4A and 4B are close-up side views of an edge portion of the display system of FIG. 2B, showing the transparent cover sheet and the adjacent capacitive touch screen, and illustrating how the proximity sensor measures a deflection of the cover sheet caused by a touching force applied to the cover sheet at a touch location. FIGS. 4C and 4D are an alternative embodiment showing a close-up side views of an edge portion of the display system wherein the proximity sensor is situated proximate to the cover sheet and illustrate another method of how the proximity sensor measures a deflection of the cover sheet caused by a touching force applied to the cover sheet at a touch location;

FIGS. 5A and 5B illustrate an example zooming function of a graphics image displayed on the display system, wherein the zooming is accomplished by the application of a touching force at a touch location;

FIGS. 6A and 6B illustrate an example page-turning function of a graphics image in the form of book pages, wherein the page turning is accomplished by the application of a touching force at a touch location;

FIG. 7 illustrates an example menu-selecting function accomplished by the application of a touching force at a touch location;

FIGS. 8A and 8B illustrate an example scrolling function, wherein the scrolling rate (velocity) (FIG. 8B) can be made faster by increasing the touching force (FIG. 8A);

FIG. 9A is similar to FIG. 8 and illustrates how the scrolling function can be made to jump from one position to the next by discretizing the force vs. scroll-bar position function;

FIG. 9B is a plot that illustrates a change in position Based on threshold amounts of applied force;

FIGS. 10A and 10B illustrate an example of how a graphics image in the form of a line can be altered by swiping combined with the application of a select amount of touching force;

FIG. 11 illustrates an example of how a display image can be expanded or panned over a field of view using the application of a select amount of touching force;

FIG. 12 illustrates an example of how a graphics image in the form of a carousel of objects can be manipulated using the application of a select amount of touching force;

FIG. 13 illustrates how the repeated application of touching force in a short period of time (pumping or pulsing) can be used rather than applying increasing amounts of touching force.

Cartesian coordinates are shown in certain of the Figures for the sake of reference and are not intended as limiting with respect to direction or orientation.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

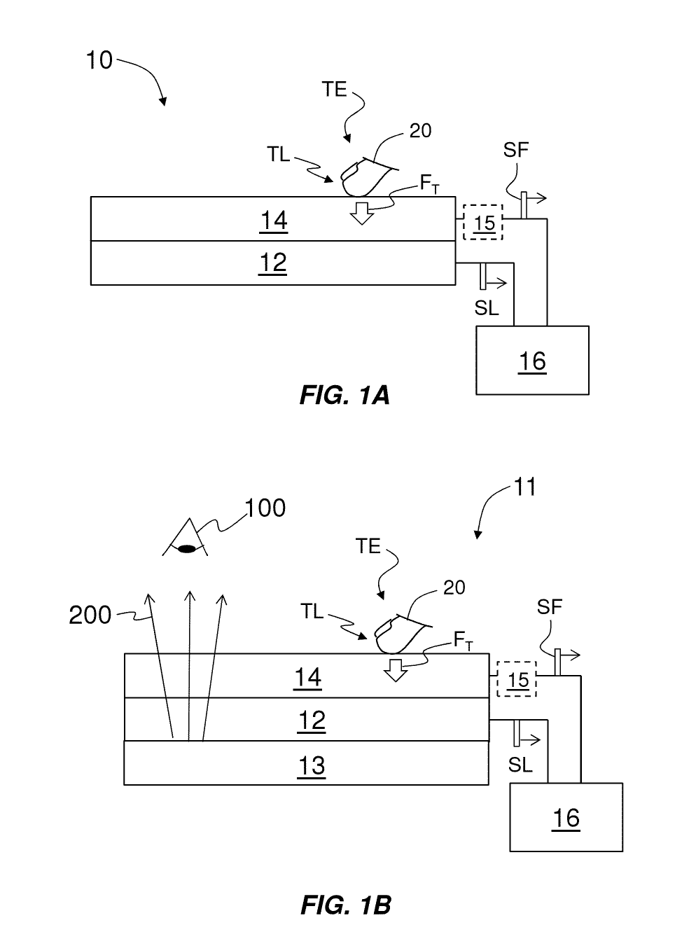

FIG. 1A is a schematic diagram of the touch screen system 10 according to the disclosure. Touch screen system 10 may be used in a variety of consumer electronic articles, for example, in conjunction with displays for cell-phones, keyboards, touch screens and other electronic devices such as those capable of wireless communication, music players, notebook computers, mobile devices, game controllers, computer “mice,” electronic book readers and the like.

Touch screen system 10 includes a conventional capacitive touch screen system 12, such as PCT touch screen. Examples of capacitive touch screen system 12 are disclosed for example in the following U.S. Pat. Nos. 4,686,443; 5,231,381; 5,650,597; 6,825,833; and 7,333,092. Touch screen system 10 also includes an optical force-sensing system 14 operably interfaced with or otherwise operably combined with capacitive touch screen system 12. Both capacitive touch screen system 12 and optical force-sensing system 14 are electrically connected to a microcontroller 16, which is configured to control the operation of touch screen system 10, as described below.

In an example, microcontroller 16 is provided along with the capacitive touch screen system 12 (i.e., constitutes part of the touch screen system) and is re-configured (e.g., re-programmed) to connect directly to force-sensing system 14 (e.g., via I2C bus) and receive process force signals SF from optical force-sensing system 14. The microcontroller 16 may also be connected to a multiplexer (not shown) to allow for the attachment of multiple sensors.

FIG. 1A shows a touch event TE occurring at a touch location TL on force-sensing system 14 by a touch from a touching implement 20, such as a finger as shown by way of example. Other types of touching implements 20 can be used, such as a stylus, the end of a writing instrument, etc. In response, optical force-sensing system 14 generates a force-sensing signal (“force signal”) SF representative of the touching force F_{T} associated with the touch event TE. Likewise, capacitive touch screen 12 generates a location-sensing signal (“location signal”) SL representative of the touch location associated with the touch event TE. The force signal SF and the location signal SL are sent to microcontroller 16. Microcontroller 16 is configured to process these signals and (e.g., via an API) to create an event object in the controller software that is based on both touch event location TL and touch event force F_{T}. In an example, microcontroller adjusts at least one feature of a display image 200 (introduced and discussed below) in response to at least one of force signal SF and location signal SL.

In an example, optical force-sensing system 14 is configured so that a conventional capacitive touch screen system 12 can be retrofitted to have both location-sensing and force-sensing functionality. In an example, optical force-sensing system 14 is configured as an adapter that is added onto capacitive touch-screen system 12. In an example, optical force-sensing system 14 optionally includes its own microcontroller 15 (shown in FIG. 1A as a dashed-line box) that is interfaced with microcontroller 16 and that conditions the force signal SF prior to the force signal being provided to microcontroller 16.

FIG. 1B is similar to FIG. 1A and is a schematic diagram of an example display system 11 that utilizes the touch screen system 10 of FIG. 1A. Display system 11 includes a display assembly 13 configured to generate a display image 200 that is viewable by a viewer 100 through touch screen system 10.

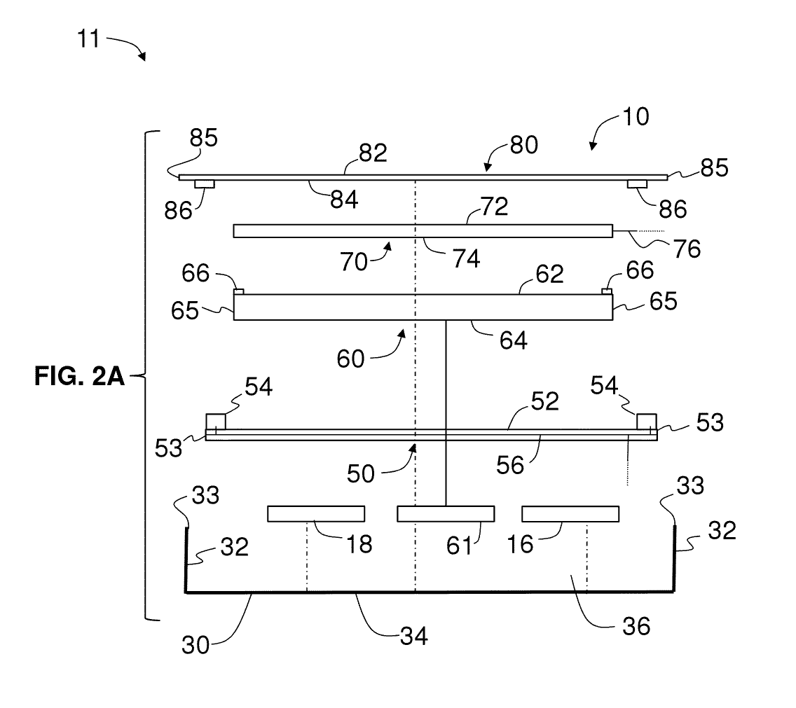

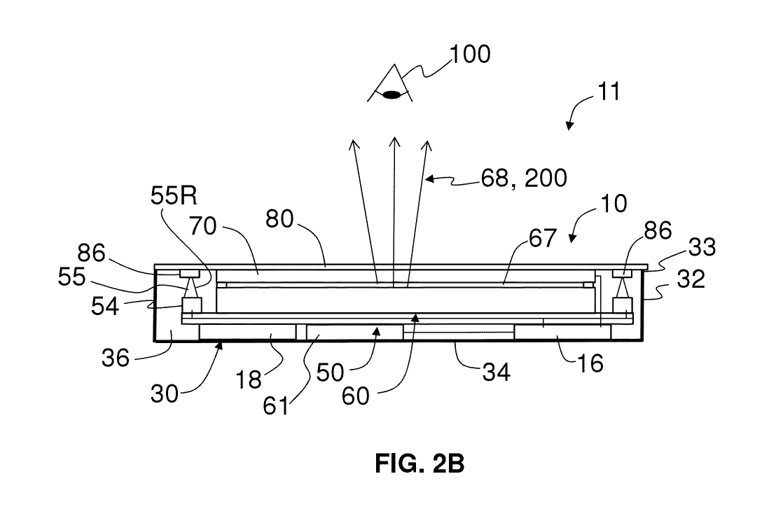

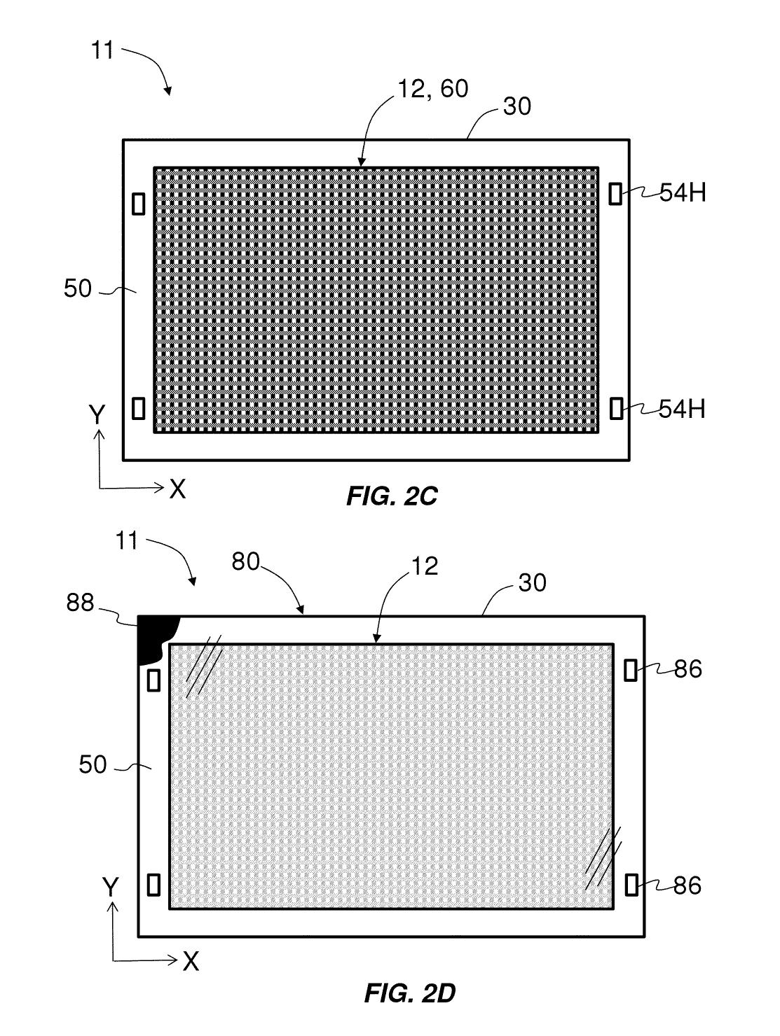

FIG. 2A is an exploded side view of an example display system 11 that utilizes touch screen system 10, while FIG. 2B is the assembled side view of the example display system of FIG. 2A. Display system 11 includes a frame 30 that has sidewalls 32 with a top edge 33, and a bottom wall 34. Sidewalls 32 and bottom wall 34 define an open interior 36. Display system 11 also includes the aforementioned microcontroller 16 of touch screen system 10, which microcontroller in an example resides within frame interior 36 adjacent bottom wall 34 along with other display system components, e.g., at least one battery 18.

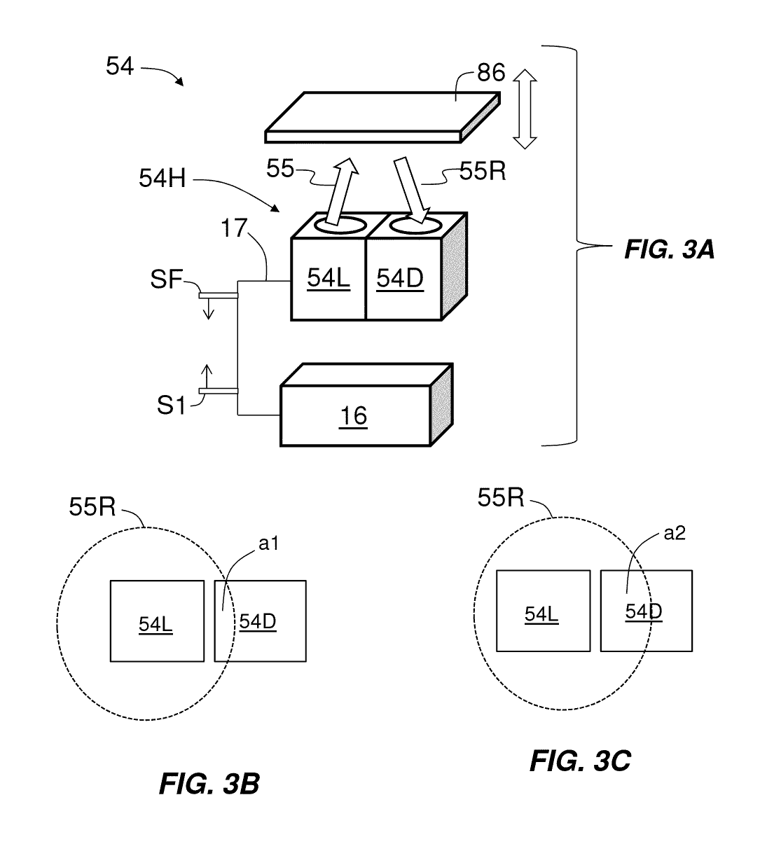

Display system 11 also includes a flex circuit 50 that resides in frame interior 36 atop microcontroller 16 and batteries 18. Flex circuit 50 has a top surface 52 and ends 53. A plurality of proximity sensor heads 54H are operably mounted on the flex circuit top surface 52 near ends 53. With reference to FIG. 3A, each proximity sensor head 54H includes a light source 54L (e.g., an LED) and a photodetector (e.g., photodiode) 54D. Flex circuit 50 include electrical lines (wiring) 56 that connects the different proximity sensor heads 54 to microcontroller 16. In an example, wiring 56 constitutes a bus (e.g., an I2C bus). Electrical lines 56 carry force signals SF SL generated by proximity sensors 54.

With reference again to FIGS. 2A and 2B, display system 11 further includes a display 60, disposed on the upper surface 52 of flex circuit 50. Display 60 has top and bottom surfaces 62 and 64 and an outer edge 65. One or more spacing elements (“spacers”) 66 are provided on top surface 62 adjacent outer edge 65. Display 60 includes a display controller 61 configured to control the operation of the display, such as the generation of display images 200. Display controller 61 is shown residing adjacent touch screen microcontroller 16 and is operably connected thereto. In an example, only a single microcontroller is used rather than separate microcontrollers 16 and 61.

Display system 11 also include a capacitive touch screen 70 adjacent display top surface 62 and spaced apart therefrom via spacers 66 to define an air gap 67. Capacitive touch screen 70 has top and bottom surfaces 72 and 74. Capacitive touch screen 70 is electrically connected to microcontroller 16 via electrical lines 76 (wiring), which in an example constitute a bus (e.g., an I2C bus). Electrical lines 76 carry location signal SL generated by the capacitive touch screen.

Display system 11 also includes a transparent cover sheet 80 having top and bottom surfaces 82 and 84 and an outer edge 85. Transparent cover sheet 80 is supported by frame 30 by the bottom surface 84 of the transparent cover sheet at or near the outer edge 85 contacting the top edge 33 of the frame. One or more light-deflecting elements 86 are supported on the bottom surface 84 of cover glass 80 adjacent and inboard of outer edge 85 so that they are optically aligned with a corresponding one or more proximity sensor head 54H. In an example, light-deflecting elements 86 are planar mirrors. Light-deflecting elements 86 may be angled (e.g., wedge-shaped) used to provide better directional optical communication between the light source 54L and the photodetector 54D of proximity sensor 54, as explained in greater detail below. In an example, light-deflecting elements are curved. In another example, light-deflecting elements comprise gratings or a scattering surface. Each proximity sensor head 54H and the corresponding light-deflecting element 86 defines a proximity sensor 54 that detects a displacement of transparent cover sheet 80 to ascertain an amount of touching force F_{T} applied to the transparent cover sheet by a touch event TE

In an example embodiment, transparent cover sheet 80 is disposed adjacent to and in intimate contact with capacitive touch screen 70, i.e., the bottom surface 84 of the transparent cover sheet 80 is in contact with the top surface 72 of capacitive touch screen 70. This contact may be facilitated by a thin layer of a transparent adhesive. Placing transparent cover sheet 80 and the capacitive touch screen 70 in contact allows them to flex together when subjected to touching force F_{T}, as discussed below.

It is noted here that the optical force-sensing system 14 of FIG. 1 is constituted by transparent cover sheet 80, light-deflecting elements 86, the multiple proximity sensors 54, flex circuit 50 and the electrical lines 56 therein. The capacitive touch screen system 12 is constituted by capacitive touch screen 70 and electrical lines 76. The display system 13 is constituted by the remaining components, including in particular display 60 and display controller 61.

With continuing reference to FIG. 2B, display 60 emits light 68 that travels through gap 67, capacitive touch screen 70 (which is transparent to light 68) and transparent cover sheet 80. Light 68 is visible to a user 100 as display image 200, which may for example be a graphics image, a picture, an icon, symbols, or anything that can be displayed. In an example embodiment, display system 11 is configured to change at least one aspect (or feature, or attribute, etc.) of the display image 200 based on the force signal SF and the location signal SL. An aspect of the display image 200 can include size, shape, magnification, location, movement, color, orientation, etc.

FIG. 2C is a top-down view of display system 11 of FIG. 2B, but without transparent cover sheet 80, while FIG. 2D the same top-down view but that in includes the transparent cover sheet. Transparent cover sheet 80 can be made of glass, ceramic or glass-ceramic that is transparent at visible wavelengths of light 68. An example glass for transparent cover sheet 80 is Gorilla Glass from Corning, Inc., of Corning, N.Y. Transparent cover sheet 80 can include an opaque cover (bezel) 88 adjacent edge 85 so that user 100 (FIG. 2B) is blocked from seeing light-deflecting elements 86 and any other components of system 10 that reside near the edge of display system 11 beneath the transparent cover sheet. Only a portion of opaque cover 88 is shown in FIG. 2D for ease of illustration. In an example, opaque cover 88 can be any type of light-blocking member, bezel, film, paint, glass, component, material, texture, structure, etc. that serves to block at least visible light and that is configured to keep some portion of display system 11 from being viewed by user 100.

FIG. 3A is a close-up elevated view of an example proximity sensor 54, which as discussed above has a sensor head 54H that includes a light source 54L and a photodetector 54D. Each proximity sensor head 54H of system 10 is electrically connected to microcontroller 16 via an electrical line 56, such as supported at least in part by flex circuit 50. Example light sources 54L include LEDs, laser diodes, optical-fiber-based lasers, extended light sources, point light sources, and the like. Photodetector 54D can be an array of photodiodes, a large-area photosensor, a linear photosensor, a collection or array of photodiodes, a CMOS detector, a CCD camera, or the like. An example proximity sensor head 54H is the OSRAM proximity sensor head, type SFH 7773, which uses an 850 nm light source 54L and a highly linear light sensor for photodetector 54D. In an example, proximity sensor 54 need not have the light source 54L and photodetector 54 attached, and in some embodiment these components can be separated from one another and still perform the intended function.

FIG. 3A also shows an example light-deflecting element 86 residing above the light source 54L and the photodetector 54D. Recall, light-deflecting element 86 is disposed on the bottom 84 of transparent cover sheet 80 (not shown in FIG. 3A). In an example, light source 54L emits light 55 toward light-deflecting element 86, which deflects this light back toward photodetector 54D as deflected light 55R. Proximity sensor head 54H and light-deflecting element 86 are configured so that when the light-deflecting element is at a first distance away and at a first orientation, the deflected light 55R covers a first area a1 of photodetector 54D (FIG. 3B). In addition, when light-deflecting element 86 is at a second distance away (and/or at a second orientation), the deflected light covers a second area a2 of the photodetector (FIG. 3C). This means that the detector (force) signal SF changes with the position and/or orientation of light-deflecting element 86.

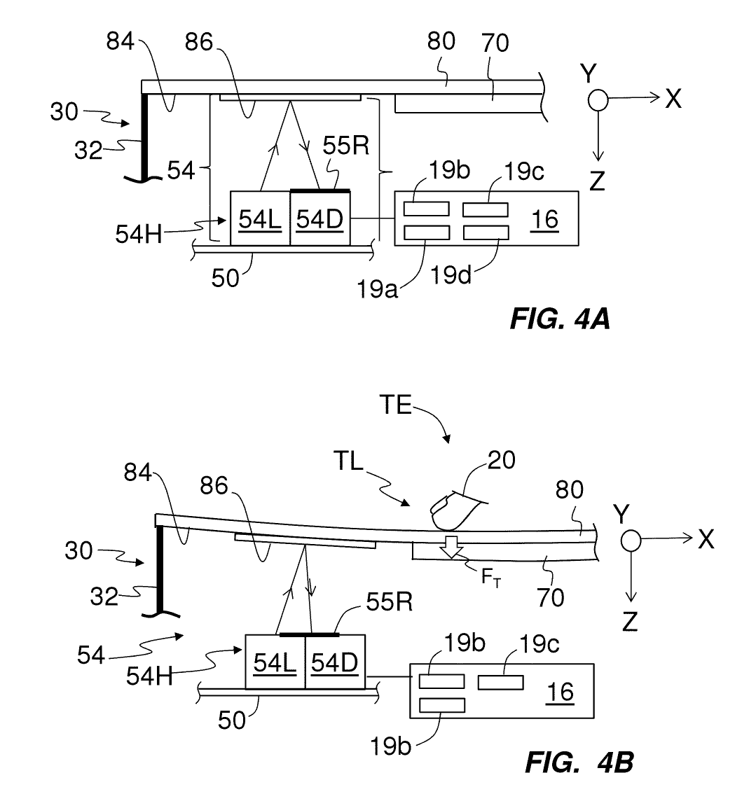

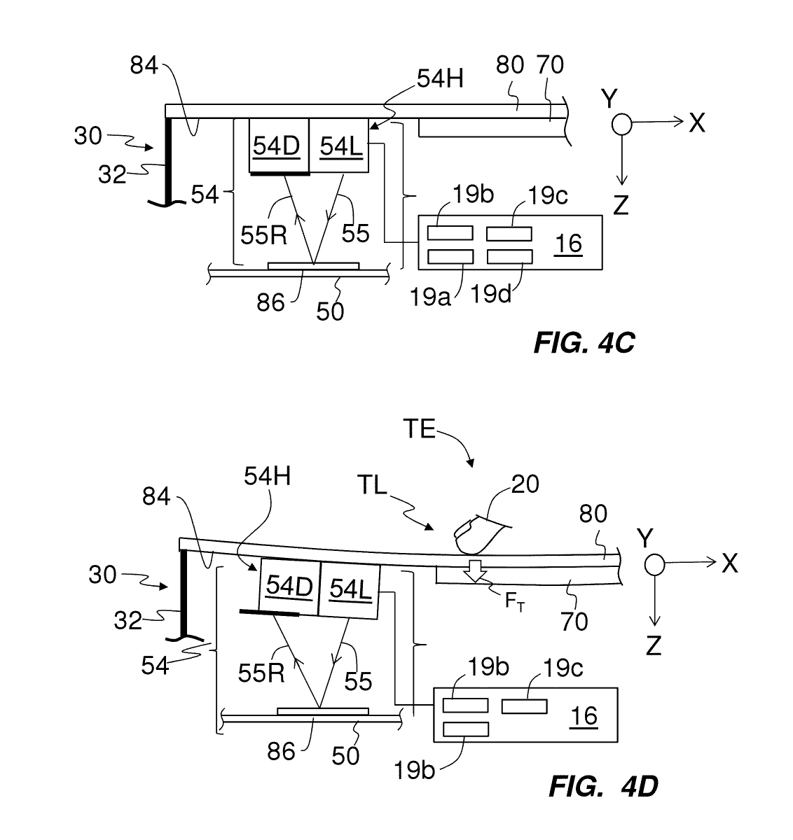

FIGS. 4A and 4B are close-up side views of an edge portion of display system 11 showing the transparent cover sheet 80 and the adjacent capacitive touch screen 70, along with one of the proximity sensors 54. In FIG. 4A, there is no touch event and display system 11 is not subject to any force by user 100. In this case, light 55 from light source 54L deflects from light-deflecting element 86 and covers a certain portion (area) of photodetector 54D. This is illustrated as the dark line denoted 55R that covers the entire detector area by way of example.

FIG. 4B illustrates an example embodiment where an implement (finger) 20 is pressed down on transparent cover sheet 80 at a touch location TL to create a touch event TE. The force F_{T} associated with the touch event TE causes transparent cover sheet 80 to flex. This acts to move light-deflecting element 86, and in particular causes the light-deflecting element to move closer to proximity sensor 54, and in some cases to slightly rotate. This in turn causes the optical path of deflected light 55R to change with respect to photodetector 54D, so that a different amount of deflected light falls upon the light-sensing surface of the photodetector. This is schematically illustrated by the dark line representing the extent of deflected light 55R being displaced relative to photodetector 54D. The change in the amount of deflected light 55R detected by photodetector 54D is represented by a change in detector (force) signal SF.

It is also noted that the deflection of transparent cover sheet 80 changes the distance between the light source 54L and photodetector 54D and this change in the distance can cause a change in the detected irradiance at the photodetector. Also in an example, photodetector 54D can detect an irradiance distribution as well as changes to the irradiance distribution as caused by a displacement in transparent cover sheet 80. The irradiance distribution can be for example, a relatively small light spot that moves over the detector area, and the position of the light spot is correlated to an amount of displacement and thus an amount of touching force F_{T}. In another example, the irradiance distribution has a pattern such as due to light scattering, and the scattering pattern changes as the transparent cover sheet is displaced.

In an alternative embodiment illustrated in FIGS. 4C and 4D, proximity detector head 54H resides on the bottom surface 84 of transparent cover sheet 80 and light-deflecting element resides, e.g., on the top surface 52 of flex circuit 50. In this alternative embodiment, electrical lines 56 in flex circuit 50 are still connected to proximity sensor head 54H.

In another example embodiment, transparent cover sheet 80, capacitive touch screen 70 and display 60 are adhered together. In this case, proximity sensor 54 can be operably arranged with respect to display 60, wherein either the proximity sensor head 54H or the light-deflecting element 86 is operably arranged on the top surface 62 of the display.

While the optical force-sensing system 14 of touch screen system 12 is described above in connection with a number of different examples of proximity sensor 54, other optical sensing means can be employed by modifying the proximity sensor. For example, proximity sensor 54 can be configured with reflective member 86 having a diffracting grating that diffracts light rather than reflects light, with the diffracted light being detected by the photodetector 54D.

Moreover, the light may have a spectral bandwidth such that different wavelengths of light within the spectral band can be detected and associated with a given amount of displacement (and thus amount of touching force F_{T} applied to) transparent cover sheet 80. Light source 54L can also inject light into a waveguide that resides upon the bottom surface 84 of transparent cover sheet 80. The light-deflecting element 86 can be a waveguide grating that is configured to extract the guided light, with the outputted light traveling to the photodetector 54D and being incident thereon in different amounts or at different positions, depending upon the displacement of the transparent cover sheet.

In another embodiment, proximity detector 54 can be configured as a micro-interferometer by having a beamsplitter included in the optical path that provides a reference wavefront to the photodetector. Using a coherent light source 54L, the reference wavefront and the reflected wavefront from light-deflecting element 86 can interfere at photodetector 54D. The changing fringe pattern (irradiance distribution) can then be used to establish the displacement of the transparent cover sheet due to touching force F_{T}.

Also in an example, proximity sensor 54 can be configured to define a Fabry-Perot cavity wherein the displacement of transparent cover sheet 80 causes a change in the Finesse of the Fabry-Perot cavity that can be correlated to amount of applied touching force F_{T} used to cause the displacement. This can be accomplished for example, by adding a second partially-reflective window (not shown) operably disposed relative to reflective member 86

The proximity sensor heads 54H and their corresponding reflective members 86 are configured so that a change in the amount of touching force F_{T} results in a change in the force signal SF by virtue of the displacement of transparent cover sheet 80. Meanwhile, capacitive touch screen 70 sends location signal SL to microcontroller 16 representative of the (x,y) touch location TL of touch event TE associated with touching force F_{T} as detected by known capacitive-sensing means. Microcontroller 16 thus receives both force signal SF representative of the amount of force F_{T} provide at the touch location TL, as well as location signals SL representative of the (x,y) position of the touch location. In an example multiple force signals SF from different proximity sensors 54 are received and processed by microcontroller 16.

In an example, microcontroller 16 is calibrated so that a given value (e.g., voltage) for force signal SF corresponds to amount of force. The microcontroller calibration can be performed that measures the change in the force signal (due to a change in intensity or irradiance incident upon photodetector 54D) and associates it with a known amount of applied touching force F_{T} at one or more touch locations TL. Thus, the relationship between the applied touching force FT and the force signal can be established empirically as part of a display system or touch screen system calibration process.

Also in an example, the occurrence of a touch event TE can be used to zero the proximity sensors 54. This may be done in order to compensate the sensors for any temperature differences that may cause different proximity sensors 54 to perform differently.

Microcontroller 16 is configured to control the operation of touch screen system 10 and also process the force signal(s) SF and the touch signal(s) SL to create a display function (e.g., for display 11 for an event object that has an associated action), as described below. In some embodiments, microcontroller 16 includes a processor 19a, a memory 19b, a device driver 19c and an interface circuit 19c (see FIGS. 4A, 4B), all operably arranged, e.g., on a motherboard or integrated into a single integrated-circuit chip or structure (not shown).

In an example, microcontroller 16 is configured or otherwise adapted to execute instructions stored in firmware and/or software (not shown). In an example, microcontroller 16 is programmable to perform the functions described herein, including the operation of touch screen system 10 and any signal processing that is required to measure, for example, relative amounts of pressure or force, and/or the displacement of the transparent cover sheet 80, as well as the touch location TL of a touch event TE. As used herein, the term microcontroller is not limited to just those integrated circuits referred to in the art as computers, but broadly refers to computers, processors, microcomputers, programmable logic controllers, application-specific integrated circuits, and other programmable circuits, as well as combinations thereof, and these terms can be used interchangeably.

In an example, microcontroller 16 includes software configured to implement or aid in performing the functions and operations of touch screen system 10 disclosed herein. The software may be operably installed in microcontroller 16, including therein (e.g., in processor 19a). Software functionalities may involve programming, including executable code, and such functionalities may be used to implement the methods disclosed herein.

Such software code is executable by the microprocessor. In operation, the code and possibly the associated data records are stored within a general-purpose computer platform, within the processor unit, or in local memory. At other times, however, the software may be stored at other locations and/or transported for loading into the appropriate general-purpose computer systems. Hence, the embodiments discussed herein involve one or more software products in the form of one or more modules of code carried by at least one machine-readable medium. Execution of such code by a processor of the computer system or by the processor unit enables the platform to implement the catalog and/or software downloading functions, in essentially the manner performed in the embodiments discussed and illustrated herein.

With reference again to FIG. 3A, microcontroller 16 controls light source 54L via a light-source signal 51 and also receives and processes a detector signal SF from photodetector 54D. The detector signal SF is the same as the aforementioned force signal and so is referred to hereinafter as the force signal. The multiple proximity sensors 54 and microcontroller 16 can be operably connected by the aforementioned multiple electrical lines 56 and can be considered as a part of optical force-sensing system 14. Thus, both the capacitive touch screen 12 and the one or more proximity sensors 54 are electrically connected to microcontroller 16 and provide the microcontroller with location signal SL and force signal(s) SF.

In an example embodiment of touch screen system 10, each force signal SF have a count value over a select range, e.g., from 0-255. In an example, a count value of 0 represents proximity sensor head 54H touching transparent cover sheet 80 (or the light-deflecting element 86 thereon), while a count value of 255 represents a situation where the light-deflecting element is too far away from proximity sensor head. During calibration, a reading a from proximity sensor 54 with no force being applied to touch screen system 10 is recorded along with the sensor reading β for a specified large amount of touching force F_{T}.

The following equation shows how the data represented by force signal SF is normalized for a given proximity sensor 54 and is also applied to the other proximity sensors as well. The normalization factor N is given by:

N=[α_{A}−A]/[α_{A}−β_{A}]·100

where A is the proximity sensor data for force signal SF, α is the proximity sensor reading with no force F_{T}, and β is the proximity sensor reading at maximum force F_{T}.

The average of the data for all the normalized proximity sensors 54 is then taken. A further rolling averaging step is used to smooth the data by taking an average of the three most recent averaged values. Table 1 below helps to illustrate this concept, wherein “Ac#n” stands for “array column #n” and AVG_{R} stands for “rolling average” for different times T. At the initial time point, a blank three-column array is initialized in microcontroller 16 and contains no values. During the first time point, the first column (AC #1) is populated with the average of all normalized sensors (labeled P1). At the next time point, the data for P1 is moved to the second column (AC #2) and AC #1 is replaced with the average of all normalized sensors at the second time point (labeled P2).

This process continues for each time point. The average of the data in the three columns is taken as the final value, which is accessed by software for various applications. The rolling average from the array is ignored until all columns have been populated. The parameter P is given by:

P=Normalized sensor data=normalized A+normalized B+normalized C+normalized D

TABLE 1

| Time T | AC #1 | AC #2 | AC #3 | AVG_{R} |
|---|---|---|---|---|
| 0 | — | — | — | — |
| 1 | P₁ | — | — | — |
| 2 | P₂ | P₁ | — | — |
| 3 | P₃ | P₂ | P₁ | A₃ |
| 4 | P₄ | P₃ | P₂ | A₄ |
| 5 | P₅ | P₄ | P₃ | A₅ |

The value for AVG_{R} was used in a custom drawing program in microcontroller 16 to modify the width of a display image in the form of a line when swiping. During the swipe, if a certain amount of force F_{T} is applied, the width of the line increases. When less force is applied, the line width is reduced.

In example embodiments of the disclosure, an amount of touching pressure or touching force (pressure=F_{T}/area) is applied at a touch location TL associated with a touch event TE. Aspects of the disclosure are directed to sensing the occurrence of a touch event TE, including relative amounts of applied force F_{T} as a function of the displacement of transparent cover sheet 80. The time-evolution of the displacement (or multiple displacements over the course of time) and thus the time-evolution of the touching force F_{T} can also be determined.

Thus, the amount as well as the time-evolution of the touching force F_{T} is quantified by proximity sensors 54 and microcontroller 16 based on the amount of deflection of transparent cover sheet 80. Software algorithms in microcontroller 16 are used to smooth out (e.g., filter) the force signal SF, eliminate noise, and to normalize the force data. In this way, the applied force F_{T} can be used in combination with the location information to manipulate the properties of graphics objects on a graphical user interface (GUI) of system 10, and also be used for control applications. Both one-finger and multiple-finger events can be monitored. The force information embodied in force signal SF can be used as a replacement or in conjunction with other gesture-based controls, such as tap, pinch, rotation, swipe, pan, and long-press actions, among others, to cause system 10 to perform a variety of actions, such as selecting, highlighting, scrolling, zooming, rotating, and panning, etc.

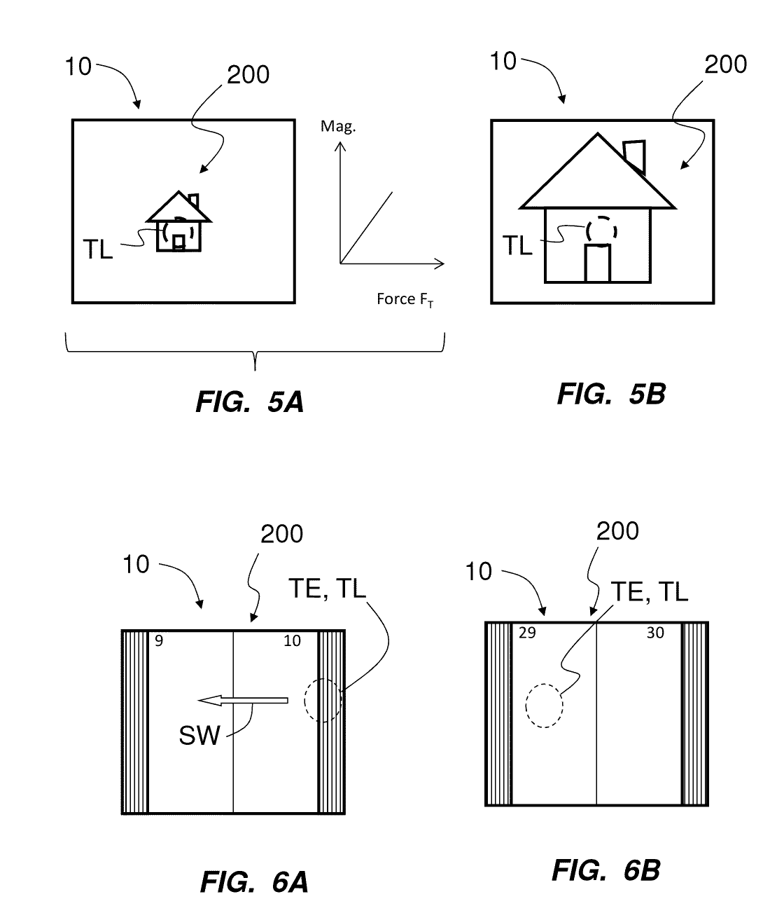

For example, with reference to FIGS. 5A and 5B, for zoom based events, a one-finger touch event TE with pressure (i.e., force F_{T}) can be used to zoom-in on an image, such as the house image 200 shown. FIG. 5B shows the zoomed-in (higher magnification) image 200. The inset plot in FIG. 5A shows an example of how the image magnification can vary with the applied force F_{T}. To zoom out, a separate two-finger event can be employed wherein reduced pressure then zooms out. The combination of touch and force is useful here since a reduction in force can be used to reset the zoom. In this case, the user presses with force to zoom in with a one finger and then wishes to zoom out by applying another finger to the touch surface and change the amount of force F_{T}.

In another example, system 10 replaces delay-based controls, such as long-press touches, to enable a faster response for an equivalent function. The touching force F_{T} can be used to change an aspect of display image 200. For example, in a drawing application, to modify the width of a line or change the brush size during use (i.e. paint brush size, erase size). For image-based applications, the force information from force signal(s) SF can be used to lighten/darken a photo or adjust the contrast. In image applications or map programs, the force data can provide the rate of image translation during panning, or the speed of image magnification during a zoom function, as discussed above.

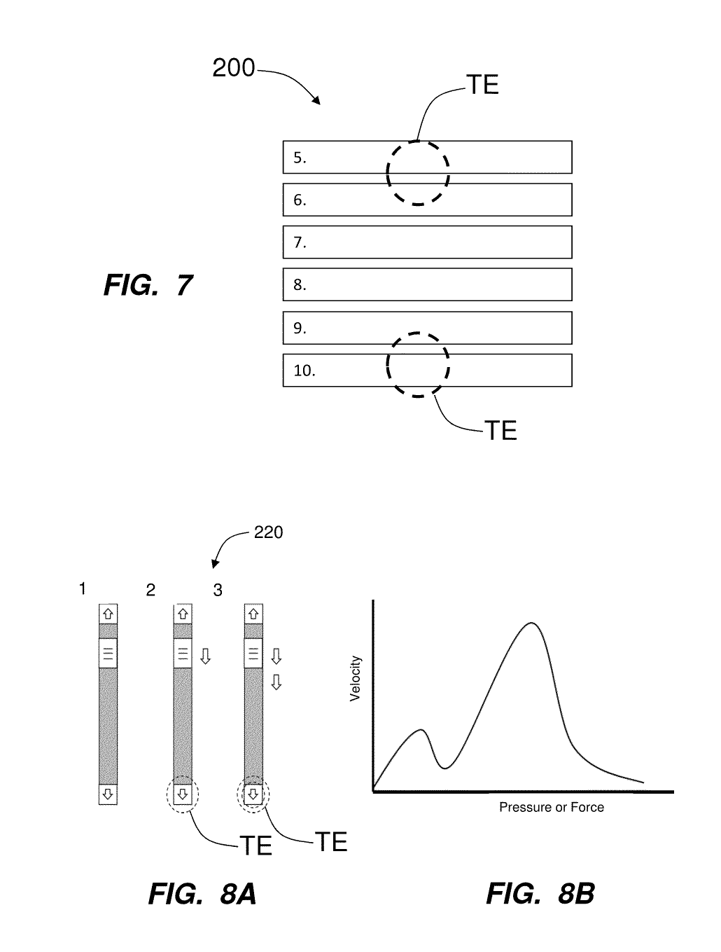

Touch-based data can be used in conjunction with another user gesture (i.e. pinch & zoom) to perform a certain action (i.e. lock, pin, crop). A hard press on the touch screen (i.e., a relatively large touching force F_{T}) can be used to cause a display image (e.g., a graphic object) to flip (front to back) or to rotate by a select amount, e.g., 90 degrees. With reference to FIGS. 6A and 6B, a touch event TE with substantial touching force F_{T} can be used in conjunction with a swipe gesture SG to turn multiple pages of a book image 200 at once. One can use force data as a velocity control during a scrolling event. Game applications will find utility to set a level of action or speed for a given graphics object or action (e.g., a golf swing, a bat swing, racing acceleration, etc.). As illustrated in FIG. 7, force data can also be employed to open submenus in a menu list 210, or to scroll through the list.

FIG. 8A shows a scroll bar 220 wherein application of increasing amounts of touching force F_{T} at a touch location that corresponds to the scrolling position increases the rate of scrolling, as shown by the untouched scroll bar (1), the initial lightly touched scroll bar (2) and the forcefully pressed scroll bar (3). The arrows in FIG. 8A indicate an increased rate of movement (velocity). FIG. 8B is a plot of velocity vs. pressure or force that can be used to manage the speed at which a graphics object moves.

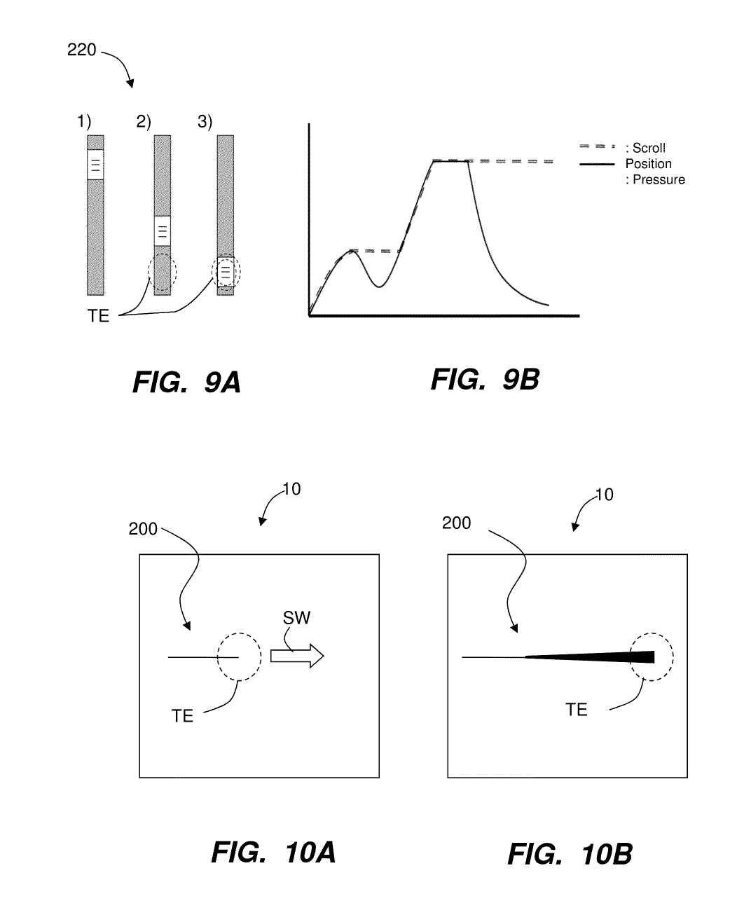

FIGS. 9A and 9B are similar to FIGS. 8A and 8B and illustrate an example embodiment where the applied touching force F_{T} can be discretized as a function of scroll position so that an object can be made to move directly from one position to another.

FIGS. 10A and 10B illustrate an example function of system 10 wherein a graphics image in the form of a line is swiped (SW) with a touching force TF at the touch location TL at one end of the line in order to expand the linewidth.

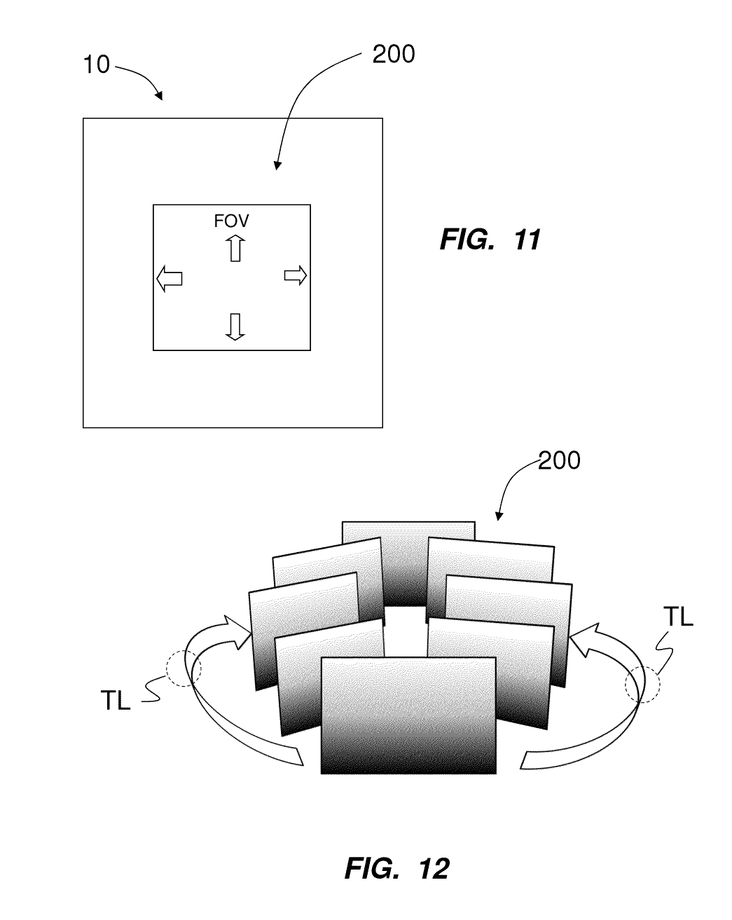

FIG. 11 is another example function of display system 10 that shows how a graphics object 200 can be panned over a field of view (FOV) by judicious application of a touching force at one or more touch locations TL on touch screen system 10. In the FOV of an electronic document (i.e. map, image, etc.), one can press a region away from the FOV center to transition the image in that direction. The more forceful a press, the faster the image translates in that direction. The primary directions would be up, down, left, or right as shown in the arrows.

FIG. 12 illustrates carousel application wherein the user can touch a select touch location TL to define direction and apply pressure to increase the rotational velocity of the different graphic objects that make up the carousel of objects.

In certain instances, there will a maximum touching force F that can be used. Rather than exceed the maximum touching force, in an example a pumping or pulsing action can be used whereby an implement 20 presses with force multiple times in a given time period. This option can be useful for applications such as gaming or in satellite imagery where the user would like to zoom in/out at a much faster rate than the applied maximum force.

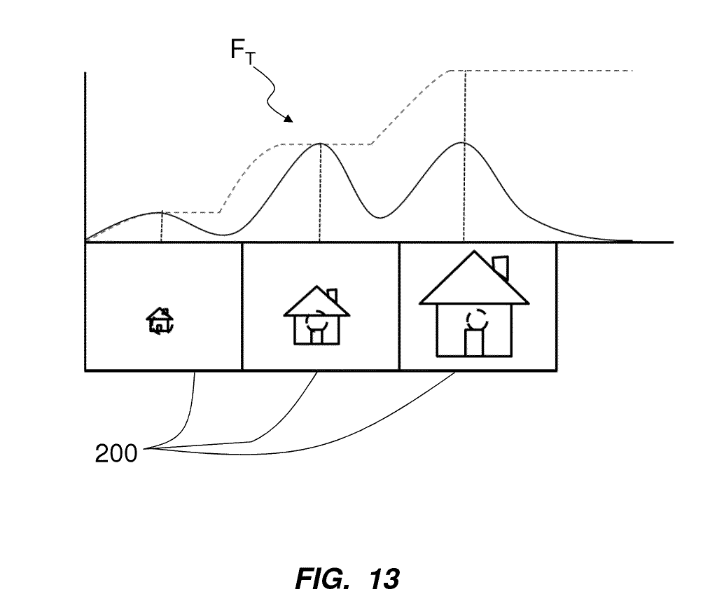

FIG. 13 schematically illustrates the use of a pumping or pulsing action at the touch location TL to traverse large amounts of data of an unknown size without the limitations of the pressure sensing resolution. In a case where direct pressure to motion translation is needed (as opposed to velocity), the user can alternate increasing and decreasing pressure using the pumping or pulsing action. In this way, decreasing pressure is ignored and the user can cease interaction by simply not applying pressure. In this example, a user can apply larger magnifications without losing the precision of direct pressure to magnification translation. Although the embodiments herein have been described with reference to particular aspects and features, it is to be understood that these embodiments are merely illustrative of desired principles and applications. It is therefore to be understood that numerous modifications may be made to the illustrative embodiments and that other arrangements may be devised without departing from the spirit and scope of the appended claims.

What is claimed is:

1. A touch screen system for displaying a display image and for sensing a touch event, comprising:
a capacitive touch system configured to sense a touch location and generate a location signal representative of a touch location for the touch event;
an optical force-sensing system operably disposed relative to the capacitive touch system and configured to optically detect a touching force applied at the touch location and generate a force signal representative of the touching force applied at the touch location; and
a microcontroller electrically connected to the capacitive touch system and the optical force-sensing system, the microcontroller configured to receive the force signal and the location signal and change an aspect of the display image based on the force signal and the touch signal.

2. The touch screen system of claim 1, wherein the capacitive touch screen system includes a capacitive touch screen with a top surface, and wherein the optical force-sensing system comprises a transparent cover sheet having a bottom surface, wherein the transparent cover sheet is arranged with its bottom surface in contact with the top surface of the capacitive touch screen.

3. The touch screen system of claim 1, wherein the optical force-sensing system includes at least one optical proximity sensor operably arranged relative to the transparent cover sheet and configured to optically sense a displacement of the transparent cover sheet due to the touching force applied at the touch location and in response generate the force signal.

4. The touch screen system of claim 3, wherein each optical proximity sensor comprises:
a light-deflecting element arranged on the bottom surface of the transparent cover sheet;
a light source and a photodetector in optical communication with the light-deflecting element, wherein the light source emits light that deflects from the light-deflecting element to form deflected light that is detected by the photodetector, and wherein the displacement of the transparent cover sheet changes the amount of deflected light detected by the photodetector.

5. The touch screen system of claim 4, wherein each sensor head is electrically connected to the microcontroller via a flex circuit that supports a plurality of electrical lines.

6. A display system for viewing a display image, comprising:
the touch screen system of claim 1; and
a display unit operably arranged relative to the touch screen system so that the display image is viewable through the touch screen system.

7. The display system of claim 6, wherein the microcontroller is also configured to control the display unit.

8. The display system of claim 6, wherein said the display unit includes display microcontroller, and wherein the touch screen microcontroller is operably connected to the display microcontroller.

9. The display system of claim 6, wherein the display unit includes a display arranged adjacent and spaced apart from the capacitive touch system.

10. The display system of claim 6, wherein the display unit is configured to change an aspect of the display image based on the force signal and the location signal received from the touch screen system.

11. A method of changing at least one aspect a displayed imaged on a display system, comprising:
capactively sensing a location of a touch event at a touch location and generating in response a touch signal representative of the touch event location;
optically sensing a touching force associated with the touch event and generating in response at least one force signal representative of the touching force;
processing the touch signal and at least one force signal to change the at least one aspect of the displayed image.

12. The method of claim 11, wherein optically sensing includes optically measuring a displacement of a transparent cover sheet of the display.

13. The method of claim 12, wherein optically measuring the displacement of the transparent cover sheet includes detecting a change in an amount of detected light as a result of a change in an optical path traveled by deflected light cause by the displacement.

14. The method of claim 12, wherein the aspect of the displayed image includes an aspect selected from the group of aspects comprising: size, shape, magnification, location, movement, color, and orientation

15. The method of claim 11, wherein the display image comprises an electronic document image having a magnification and wherein changing the at least one aspect of the displayed image includes changing the magnification.

16. The method of claim 11, wherein the display image comprises an electronic document image having multiple pages, and wherein changing the at least one aspect of the displayed image includes changing the page.

17. The method of claim 11, wherein the display image comprises a scrollbar having a scrolling speed, and wherein changing the at least one aspect of the displayed image includes changing the scroll speed.

18. The method of claim 11, wherein the display image comprises a line having a width, and wherein changing the at least one aspect of the displayed image includes changing the width of the line.

19. The method of claim 11, wherein the touching force comprises a series of pulsations.

20. The method of claim 11, wherein optical sensing a touching force includes measuring a displacement of a transparent cover sheet with multiple optical sensors, and wherein the method further comprises:
normalizing multiple force signals from the multiple optical sensors; and
taking the rolling average of the optical sensors for two or more time periods.
